(19) United States
(12) Patent Application Publication
(10) Pub. No.: US 2012/0002401 A1
(43) Pub. Date: Jan. 5, 2012

(54) LIQUID COOLED LED LIGHT BULB

(76) Inventor: Scott Allen Clifford, Mesa, AZ (US)

(21) Appl. No.: 13/174,749

(22) Filed: Jun. 30, 2011

Related U.S. Application Data
(60) Provisional application No. 61/360,090, filed on Jun. 30, 2010.

(51) Int. Cl. F21V 33/00

(52) U.S. Cl. 362/101

(57) ABSTRACT

Disclosed is a liquid cooled LED light bulb comprising at least one shaped tube positioned so as to conduct ambient heat away from the LED light source using passive cooling. In the most preferred embodiments of the present invention, a plurality of shaped tubes are arranged in an array and attached by various methods to the LED light source of the LED light bulb. The tubes of the cooling array may be in any closed circuit geometry and configured so as to contain any interior liquid that is suitable for the conduction of heat. In certain preferred embodiments of the present invention, a plurality of tubes may be arranged in a circular array or any other array configuration. In certain preferred embodiments of the present invention, an array of tubes may be below an LED mounting, but other configurations may include a tubular array substantially surrounding the LED mounting. Further, certain preferred embodiments of the present invention may comprise a protective housing or case that serves to prevent inadvertent damage to the cooling array of the LED light bulb.

### RELATED APPLICATION

This application claims priority under 35 U.S.C. §119 (e) to the filing date of U.S. Provisional Patent Application Ser. No. 61/360,090, entitled “Liquid Cooled LED Light Bulb,” which application was filed on Jun. 30, 2010 and the disclosure of which is incorporated herein by reference.

### BACKGROUND OF THE INVENTION

1. Technical Field

The present invention relates to LED light bulbs and more particularly relates to methods and techniques for addressing thermal cooling issues related to LED light bulbs.

2. Background Art

Light Emitting Diodes (“LEDs”) with an input power of 1 Watt or more are difficult to use in large arrays due to thermal problems. A large portion of the electrical energy consumed by LEDs is converted to heart. A LED is usually very small, on the order of a few mm² or less. When a large amount of heat is generated in such a small object, special care must be taken to avoid a large or uneven thermal gradient between the LED and the media to which the heat energy must be transported for cooling. The cooling of high power LEDs, most notably when such LEDs are arranged in arrays, often employs metals with high thermal conductivities, such as copper. Furthermore, arrays of LEDs may be difficult to cool evenly since the LEDs in the center of the array may be hotter than those at the periphery of the array. In the case of a projector system using an LED as a light source, various cooling methods have been used to prevent temperatures from rising to the point of damaging the light source. Direct forced air cooling is common, along with various arrangements of separated finned heat sinks, and active cooling means using heat pumps, such as Peltier coolers. Heat pipes may be used to transport heat to a heat sink to avoid the ingress of contaminants. An example of this can be found in U.S. Pat. No. 7,578,595. The life of an LED depends on the heat of its environment. Above a certain temperature, the lifespan of the LED bulb shortens significantly. Regulating the maximum temperature through cooling processes may lengthen the life span of the bulb.

### BRIEF SUMMARY OF THE INVENTION

Disclosed is a liquid cooled LED light bulb comprising at least one shaped tube positioned so as to conduct ambient heat away from the LED light source using passive cooling. In the most preferred embodiments of the present invention, a plurality of shaped tubes are arranged in an array and attached by various methods to the LED light source of the LED light bulb. The tubes of the cooling array may be in any closed circuit geometry and configured so as to contain any interior liquid that is suitable for the conduction of heat. In certain preferred embodiments of the present invention, a plurality of tubes may be arranged in a circular array or any other array configuration. In certain preferred embodiments of the present invention, an array of tubes may be below an LED mounting, but other configurations may include a tubular array substantially surrounding the LED mounting. Further, certain preferred embodiments of the present invention may comprise a protective housing or case that serves to prevent inadvertent damage to the cooling array of the LED light bulb.

### BRIEF DESCRIPTION OF THE FIGURES

The preferred embodiments of the present invention will hereinafter be described in conjunction with the appended drawings, wherein like designations denote like elements, and:

FIG. 1 is an isometric view of an LED light bulb with an integrated heat sink in accordance with a preferred exemplary embodiment of the present invention;

FIG. 2 is a sectional view of a integrated heat sink array in accordance with a preferred exemplary embodiment of the present invention;

FIG. 3 is a side view of a integrated heat sink array in accordance with a preferred exemplary embodiment of the present invention;

FIG. 4 is a perspective view of a integrated heat sink array with heat sink fins in accordance with a preferred exemplary embodiment of the present invention;

FIG. 5 is a perspective view of a heat sink plug in accordance with a preferred exemplary embodiment of the present invention;

FIG. 6 is a perspective view of a liquid cooled LED light bulb and protective casing in accordance with a preferred exemplary embodiment of the present invention;

FIG. 7 is a perspective view of a liquid cooled LED light bulb with the protective casing removed in accordance with a preferred exemplary embodiment of the present invention; and

FIG. 8 is a perspective view of heat vanes used in conjunction with a liquid cooled LED light bulb in accordance with a preferred exemplary embodiment of the present invention.

### DETAILED DESCRIPTION

Disclosed is a liquid cooled LED light bulb comprising at least one shaped tube positioned so as to conduct ambient heat away from the LED light source using passive cooling. In the most preferred embodiments of the present invention, a plurality of shaped tubes are arranged in an array and attached by various methods to the LED light source of the LED light bulb. The tubes of the cooling array may be in any closed circuit geometry and configured so as to contain any interior liquid that is suitable for the conduction of heat. In certain preferred embodiments of the present invention, a plurality of tubes may be arranged in a circular array or any other array configuration. In certain preferred embodiments of the present invention, an array of tubes may be below an LED mounting, but other configurations may include a tubular array substantially surrounding the LED mounting. Further, certain preferred embodiments of the present invention may comprise a protective housing or case that serves to prevent inadvertent damage to the cooling array of the LED light bulb.

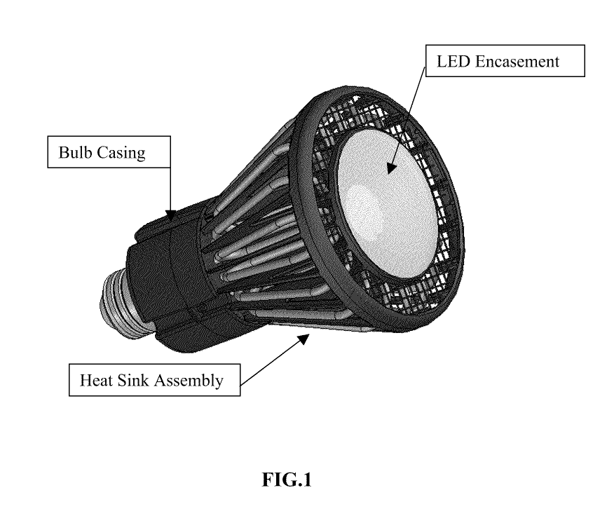

Two specific and distinct, non-limiting exemplary embodiments of the LED light bulb of the present invention are depicted in FIG. 1 and FIG. 3. Those skilled in the art will recognize that the specific exemplary inventive embodiments of FIG. 1 and FIG. 3 are capable of multiple variations and adaptations, including the incorporation of additional materials and techniques that have been implemented in other LED light bulbs.

Implementations of liquid-cooled LED light bulbs in accordance with the various preferred embodiments of the present invention may include from one to a plurality of shaped tubes arranged in an array and attached by various methods to the housing or body of the LED light bulb. The tubes may be in any closed circuit geometry as to contain any interior liquid. In certain preferred embodiments of the present invention, a plurality of tubes may be arranged in a circular array or any other array configuration. In other preferred embodiments of the present invention, an array of tubes may be positioned below an LED mounting, but other preferred embodiments of the present invention may include a tubular array substantially surrounding the LED mounting.

Referring now to FIG. 1, an isometric view of a liquid cooled LED light bulb 100 with an integrated heat sink in accordance with a preferred exemplary embodiment of the present invention comprises an LED encasement, a bulb housing, and a heat sink assembly. The LED light source of liquid cooled LED light bulb 100 comprises any type of LED that is capable of producing a light sufficient for the desired lighting application.

The LED encasement encloses and houses the LED light source for liquid cooled LED light bulb 100. The heat sink assembly is shown in this specific preferred exemplary embodiment as an array of substantially circular tubes configured and positioned so as to substantially surround the LED light source. The bulb casing is the housing for the LED light source and heat sink assembly and may comprise an appropriate externally threaded neck, allowing liquid cooled LED light bulb 100 to be removably inserted into a standard lighting fixture. Additionally, as shown in FIG. 1, a mesh like protective covering may be positioned over certain portions of the area surrounding the LED light source or other portions of the liquid filled cooling tubes, as desired to protect the interior of the liquid cooled LED light bulb 100 while simultaneously providing for the heat generated by the LED light source to escape the housing or casing of liquid cooled LED light bulb 100.

In the most preferred embodiments of the present invention, the LED light source is electrically connected to an external fitting, suitable for transferring electrical energy from an external source to the LED light source. Any method and materials (e.g., standard wiring, cables, electrical connectors, etc.) known to those skilled in the art may be used to connect an external electrical energy source to the LED light source. The housing for liquid cooled LED light bulb 100 may contain such apertures, tunnels tubes, channels, etc. as may be required to route any electrical connections from the external power source to the LED light source.

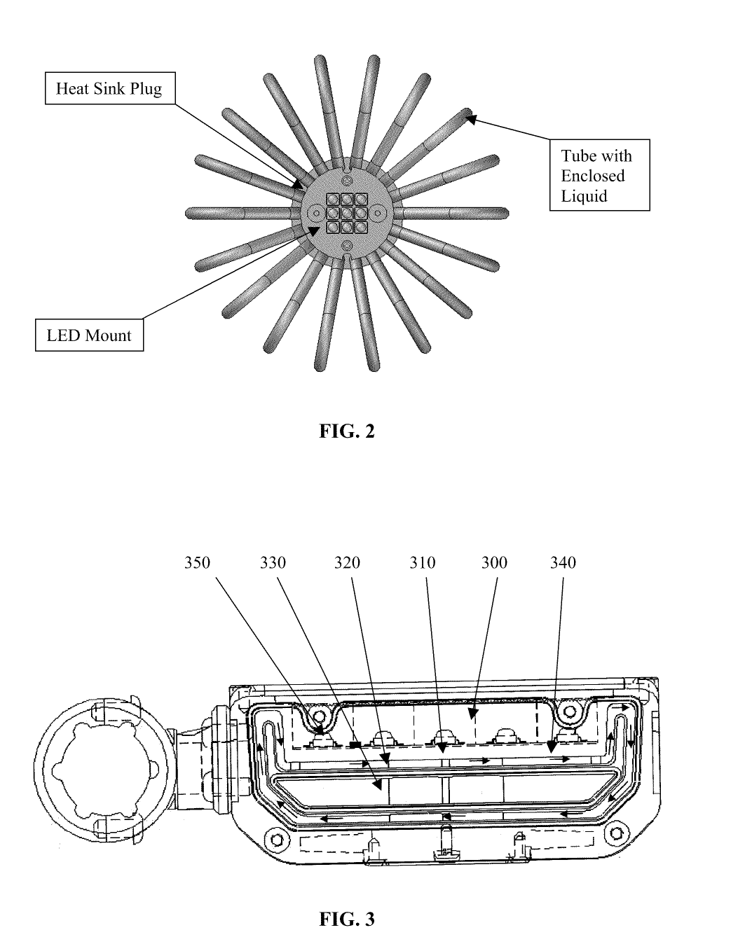

Referring now to FIG. 2, a heat sink array in accordance with a preferred embodiment of the present invention is shown. As shown in FIG. 2, a plurality of liquid filled tubes are arranged in a fan-like array around the LED mount, substantially surrounding the periphery of the LED mount and the associated LED light source. The LED mount comprises a plurality of LED light sources. The liquid filled tubes are affixed to a heat sink plug. Additional information about the heat sink plug is presented in conjunction with FIG. 5.

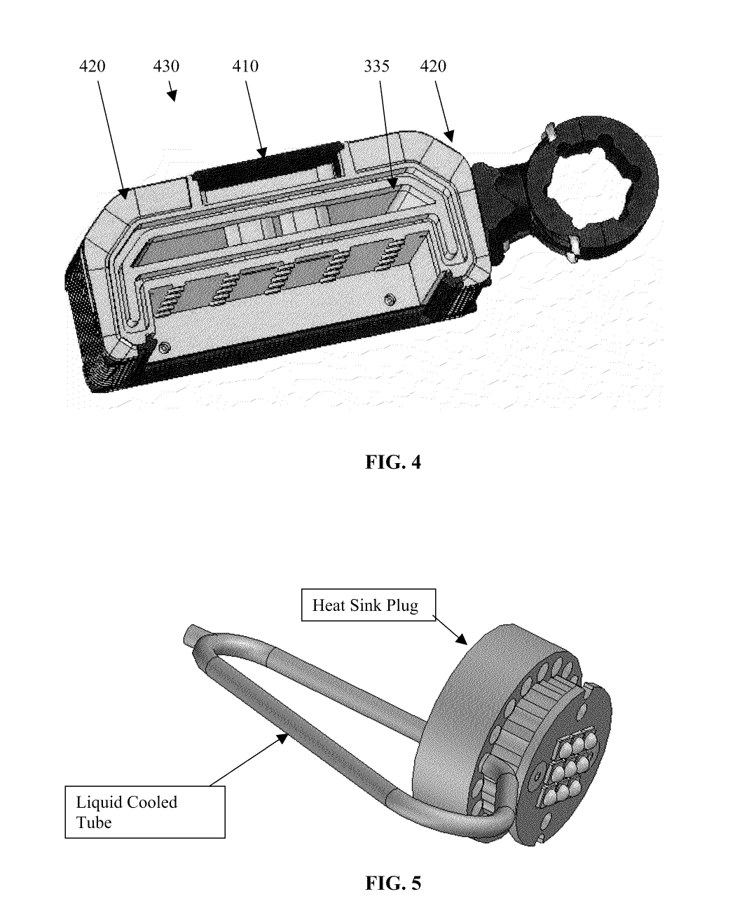

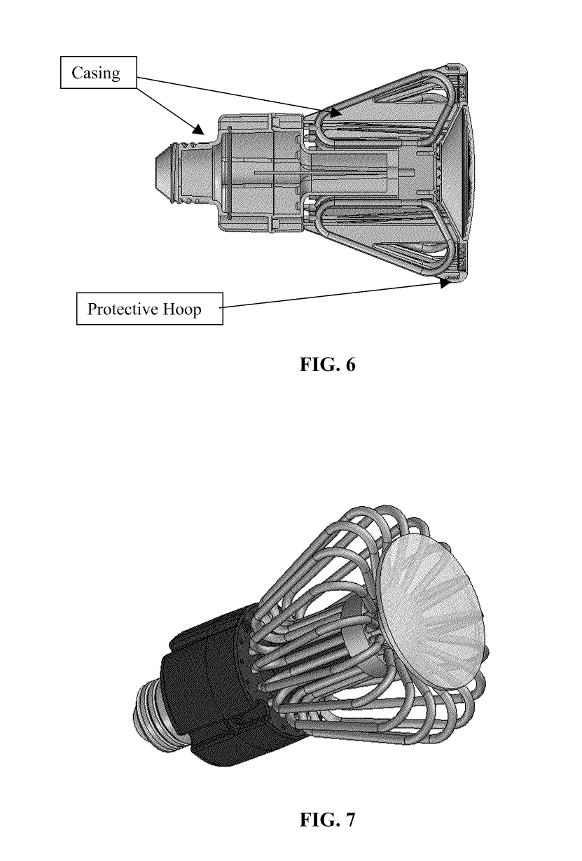

The most preferred embodiments of the heat sink portion of LED light bulb 100 may include one or more tubes that have any cross-section and loop geometry conducive to heat transfer and bulb shape. Certain preferred embodiments of the heat sink portion of LED light bulb 100 may have a circular cross-section, as depicted in FIG. 1, FIG. 2, FIG. 5, FIG. 6, and FIG. 7, while other embodiments may employ a wide, flattened cross-section, as in FIG. 3 and FIG. 4, though these two examples do not represent all possible configurations.

The liquid contained inside the tubes of the heat sink portion of liquid cooled LED light bulb 100 will most preferably have a high specific heat capacity and thus be passively induced into flowing due to its thermal gradient. Examples of desirable liquids are any liquids that are known to have a low-viscosity and high specific heat capacity, such as, but not limited to, any mixture of water, alcohol, and ethylene glycol.

Heat generated in the array of LEDs contacts the surface layer of the tubes of the heat sink portion of liquid cooled LED light bulb 100. The surface of the tubes, which comprise a metal or other heat conductive material, when exposed to the heat generated by the LED array, will conduct the heat so that it eventually reaches the liquid coolant contained within the tubes, thereby tending to induce a substantially circular passive flow of the liquid contained with the tubes. As this passive flow continues, the heat radiated from the LED light source is gradually transferred away from the LED light source and dissipated in other parts of the housing or case of LED light bulb 100 and eventually transferred to the surrounding air.

When the outer surface of the tubes are heated, the temperature rises on the inside surface of the surface layer and will generally induce a substantially laminar flow of liquid coolant within the tubes. One particular preferred embodiment of the present invention may include an interior baffle 330 within the device to direct the convective flow against one or more finned heat sinks Certain embodiments may include control circuitry for an LED array that may sample the temperature of a cooling medium to determine an LED temperature due to the temperature drop in the cooling system.

An embodiment of a device may use a liquid medium, which as seen in FIG. 3, may be contained in a convective channel 320. In this embodiment, heat flows from an LED array (300) through a metal separating wall 310 into a convective channel. The liquid medium is most preferably any readily available, low-viscosity fluid with a high specific heat, such as, but not limited to, any mixture of water, alcohol, and ethylene glycol.

Heat flows from an LED light source or LED array 300 to a convective channel 320 due to a thermal gradient that may exist between the LED array and a cooling medium in the channel. A liquid in a cooling channel 320 is heated when the temperature rises in the channel wall 310. A higher temperature may decrease the fluid density that may cause fluid to rise. Movement of a fluid will generally induce a convective flow in a direction as shown by the arrows 340 in FIG. 3.

In certain configurations, a convective flow channel 320 may be located in a void between a channel wall 310 and a convective baffle 330. The purpose of a baffle may be to direct a convective flow, as shown by the arrows 340, against a wall of the case. The center of a flow baffle (330) may be hollow, exposed to the outside air, or a combination of the two.

Referring now to FIG. 4, one preferred embodiment of the liquid cooled LED light bulb of the present invention comprises a flow baffle 330. A 3-dimensional view of particular implementation which includes a flow baffle 330. In certain configurations, the top, back, and bottom of a case are covered with finned heat-sinks 420 that serve to conduct or exchange ambient heat from a convective flow channel 320 to outside air 430. Additional heat vanes may be positioned in thermal contact with the channel so as to more rapidly dissipate the quantity of heat generated by the LED array.

As the temperature rises in a convective flow channel, so does the pressure in the channel. As a result, a convective flow channel 320 may be sealed in such a manner as to contain a maximum pressure and any safety factor that may be included.

In certain embodiments, a case may include a recess such that a controller PCB 410 may be fitted. Exposure of a controller PCB 410 to a temperature in a convective flow channel 320 may allow the controller to sense an average temperature of the LEDs 300. A temperature sensor 350, as shown in FIG. 1, may allow a spot temperature of an LED array to be measured. In certain configurations, a difference in temperature between a convective flow channel 320 and an LED temperature 350 may be used to sense fault conditions, such as a fluid or pressure leak.

In the event of high ambient temperature or high LED output a controller may regulate the output power of an LED array to a pre-programmed maximum temperature.

Various configurations of the device shown and/or described in this disclosure may have parts attached through mechanical fasteners, solder, resins, or other attachment methods. In certain implementations, the tubes may be soldered to the plug to increase the thermal contact between a heat vane and the plug. The soldered assembly may be heat treated to make the solder flow even and improve the consistency of the thermal properties throughout the bulb. Other implementations may allow for other attachment methods such as press fitting, epoxies, or other mechanical methods. The plug may be attached to zero, one, or more other layers between the plug and the chip on which the LED's are mounted by any of the aforementioned attachment methods.

Referring now to FIG. 5, a heat sink plug with a liquid filled cooling tube is shown. As shown in FIG. 5, each liquid filled cooling tube is affixed to the heat sink plug and passes through an aperture formed in the body of the heat sink plug. Additionally, each liquid filled cooling tube has a stub portion at the distal end. The stub portion can be used to connect each liquid filled cooling tube to the base portion of the casing or housing for liquid cooled LED light bulb 100.

Certain preferred embodiments of the liquid cooled LED light bulb of the present invention may comprise a heat sink plug. The heat sink plug may have a feature to orient the heat sink on the mounting feature of the bulb, such as, but not limited to pins, slots, a keyed pin, or a shaped pin, such as the square pin configuration shown in FIG. 5. Additional preferred embodiments of the liquid cooled LED light bulb of the present invention may include slots, keyed holes, holes or other features on the plug that allow for orientation and attachment of the cooling tubes to the heat sink plug. Other implementations may include other methods of attachment of the cooling tubes to the plug, including, but not limited to soldering without mechanical attachment, mechanical attachment only, or casting instead of assembly.

Referring now to FIG. 6, the profile of a liquid filled cooling tube is similar to a obtuse triangle with rounded vertices. In certain preferred embodiments of the present invention, the interior space defined by the perimeter of the liquid filled cooling tubes may comprise an additional heat sink material, such as a metal mesh or similar material that can be used to enhance the heat transfer capability of the liquid filled cooling tubes.

Certain preferred embodiments of the liquid cooled LED light bulb of the present invention may include a protective casing around the LED mount, the heat sink and the liquid filled tubes, and any combination of these and any other part on the device. Certain preferred embodiments of the liquid cooled LED light bulb of the present invention may include a meshed structure, a circular array of beams, or any combination of these and any other structural methods of a protective casing, such as seen in FIG. 1. Certain preferred embodiments of the liquid cooled LED light bulb of the present invention may include a housing comprising a protective hoop and casing around the LED bulb, such as that illustrated in FIG. 6. For example, a thick plastic ring may surround the top of a can light where the bulb is widest in diameter.

Certain preferred embodiments of the liquid cooled LED light bulb of the present invention may include a separate plastic casing for the electrical housing and the tubular coolant casings that contain the liquid. Other preferred embodiments of the liquid cooled LED light bulb of the present invention may comprise a single unitary part for the casing while others may have several cooperating parts. The casing may be attached by any method including but not limited to mechanical fasteners (e.g., nuts, bolts, and screws) or adhesives (e.g., epoxies and the like). The electrical housing may include electrical conduits that lead to the LED mounting and in particular configurations may lead to an interface feature adapted to mount the liquid cooled LED light bulb into one or more light fixtures, such as a standard externally threaded light bulb end for insertion into a standard household light bulb socket or other similar household light fixture. In this fashion, the electrical energy from the external power source that is connected to the household light fixture can be transferred to the LED light source of the liquid cooled LED light bulb and used to power the LED light source.

Certain preferred embodiments of the liquid cooled LED light bulbs of the present invention may include a separate, sealed section containing a LED source, such as those exemplary embodiments shown in FIG. 5 and FIG. 6. Features of these preferred embodiments may include any combination of reflective focusing shapes and surfaces such as a parabolic or hyperbolic surfaces placed over the LED light source so as to shape and/or direct the illumination generated by the LED light source. These preferred embodiments may also be capped with a transparent surface such as but not limited to a Fresnel lens, simple lens, window, or compound lens. In certain preferred embodiments of the device, the exterior lens may be solid; however other preferred embodiments may include a fluid lens or another type of transparent or semi-transparent lens with or without an opening or aperture. Those skilled in the art will recognize that the specific design parameters for the housing, lenses, and casing of the liquid cooled LED light bulbs of the present invention will be dictated by the overall performance requirements of a specific lighting application.

Referring now to FIG. 7, the casing or housing of liquid cooled LED light bulb 100 has been removed, showing the arrangement of the exposed liquid filled cooling tubes, the heat sink plug, and the LED light source assembly. In certain preferred embodiments of the present invention, the liquid filled cooling tubes may be in physical contact with the LED encasement housing the LED light source. In this embodiment, heat transfer away from the LED light source may be accomplished via conduction as well as convection.

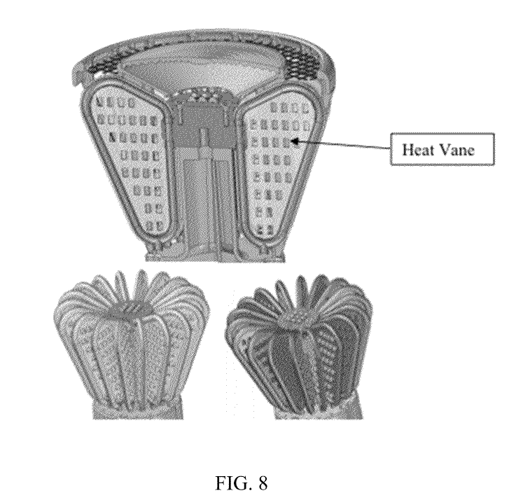

Referring now to FIG. 8, a plurality of heat vanes are shown disposed in the interstitial space defined by the perimeter of each liquid filled cooling tube. The heat vanes are most preferably manufactured from a thermally conductive material and are positioned so at to be in thermal contact with the liquid filled cooling tubes. This will allow conduction of the heat from the liquid filled cooling tubes to the heat vanes, thereby speeding the dissipation of the heat from the LED light source or LED array to the ambient air. As shown in FIG. 8, the heat vanes comprise a plurality of open spaces, allowing the ambient air to circulate in and through the surface of the heat vanes.

The various preferred embodiments of the liquid cooled LED light bulbs of the present invention may have the following advantages over the current state-of-the-art:
May last longer due to the reduced operating temperature.
Moving fluid has a thermal conductivity much greater than any readily available metal, which may realize a considerable cost and weight savings.
May allow for higher operating temperatures than other LED systems.
May result in a cooler bulb to reduce ambient cooling costs.

The components used for the liquid cooled LED light bulbs shown herein may be made of conventional materials used to make goods similar to these in the art, such as, by non-limiting example, zinc-coated aluminum, copper, other metals, glass, polycarbonate, polyvinylchloride (PVC) or other rigid or flexible rubbers, plastics, or resins. Liquids used in the cooling tubes of the liquid cooled LED light bulbs may include materials appropriate for heat transfer such as, but not limited to water, glycol, alcohol, or any combination of these or other appropriate liquids. Those of ordinary skill in the art will readily be able to select appropriate materials and manufacture these products from the disclosures provided herein.

From the foregoing description, it should be appreciated that a liquid cooled LED light bulb is provided by the various preferred embodiments of the present invention and that the various preferred embodiments offer significant benefits that would be apparent to one skilled in the art. Furthermore, while multiple preferred embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claim

1. A liquid cooled LED light bulb comprising:
a heat sink plug;
an LED light source affixed to the heat sink plug;
at least one liquid filled cooling tube affixed to the heat sink; and
a housing containing the heat sink plug, the LED light source, and the at least one liquid filled cooling tube.

2. The liquid cooled LED light bulb water of claim 1 wherein the at least one liquid filled cooling tube comprises a tube containing a fluid comprising at least one of water, alcohol, and ethylene glycol.

3. The liquid cooled LED light bulb water of claim 1 wherein a cross section of the at least one liquid filled cooling tube is substantially circular.

4. The liquid cooled LED light bulb of claim 1 wherein the housing further comprises an externally threaded neck the externally threaded neck being adapted to being removably inserted into a standard household light fixture.

5. The liquid cooled LED light bulb of claim 1 wherein the at least one liquid filled cooling tube comprises a plurality of liquid filled cooling tubes affixed to the heat sink plug, the plurality of liquid filled cooling tubes being arrayed around a perimeter of the LED light source, each of the plurality of liquid filled cooling tubes containing a liquid suitable for heat transfer, and wherein a cross section of each of the plurality of liquid filled cooling tubes is substantially circular.

6. The liquid cooled LED light bulb of claim 1 further comprising a protective hoop positioned around a perimeter of the housing.

7. The liquid cooled LED light bulb of claim 1 wherein the housing further comprises a lens covering the LED light source affixed to the heat sink plug.

8. The liquid cooled LED light bulb of claim 1 wherein the housing comprises a heat resistant plastic.

9. The liquid cooled LED light bulb of claim 1 wherein the LED light source generates a quantity of heat and wherein the quantity of heat induces a passive flow of a liquid in the at least one liquid filled cooling tube affixed to the heat sink.

10. The liquid cooled LED light bulb of claim 1 wherein the at least one liquid filled cooling tube comprises a thermally conductive metal cooling tube.

11. The liquid cooled LED light bulb of claim 1 further comprising a heat vane positioned in an interior space defined by the perimeter of the at least one liquid filled cooling tube, the heat vane conducting a quantity of heat away from the at least one liquid filled cooling tube.

12. A liquid cooled LED light bulb comprising:
a liquid filled convective channel;
an LED array;
a separating wall positioned between the LED array and the convective channel, wherein the LED array generates a quantity of heat, and wherein the quantity of heat is transferred from the LED array to the liquid filled convective channel via the separating wall;
a housing containing the convective channel, the separating wall, and the LED array.

13. The liquid cooled LED light bulb of claim 12 wherein the convective channel comprises
a substantially wide and flat cross section.

14. The liquid cooled LED light bulb water of claim 12 wherein the liquid filled convective channel comprises a convective channel containing a fluid comprising at least one of water, alcohol, and ethylene glycol.

15. The liquid cooled LED light bulb of claim 12 wherein the LED array generates a quantity of heat and wherein the quantity of heat induces a passive flow of a liquid in the convective channel.

16. The liquid cooled LED light bulb of claim 12 wherein the convective channel is in thermal contact with a plurality of finned heat sinks

17. The liquid cooled LED light bulb of claim 12 further comprising a temperature sensor, the temperature sensor being configured to detect a leak of a liquid from the liquid filled convective channel.

18. A liquid cooled LED light bulb comprising:
a heat sink plug, the heat sink plug comprising a plurality of apertures formed in the heat sink plug;
an LED light source affixed to an LED mount, the LED mount being affixed to the heat sink plug, the LED light source comprising at least one LED light;
an LED encasement enclosing the LED light source, the LED encasement comprising a lens covering at least a portion of the LED light source and the LED mount affixed to the heat sink plug;
a plurality of liquid filled cooling tubes affixed to the heat sink plug and being arrayed around a perimeter of the LED light source, each of the plurality of liquid filled cooling tubes containing a fluid comprising at least one of water, alcohol, and ethylene glycol, each of the plurality of liquid filled cooling tubes passing through one of the plurality of apertures formed in the heat sink plug; and
a housing containing the heat sink plug, the LED encasement and the light source, and the plurality of liquid filled cooling tubes, the housing comprising an externally threaded neck the externally threaded neck being adapted to being removably inserted into a standard household light fixture.
